(19) United States
(12) Patent Application Publication
(10) Pub. No.: US 2012/0298399 A1
(43) Pub. Date: Nov. 29, 2012

(54) FIRE RESISTANT CABLE

(76) Inventors: Graeme Alexander, Tottenham (AU); Ivan Ivanov, Tottenham (AU)

(21) Appl. No.: 13/443,060

(22) Filed: Apr. 10, 2012

(30) Foreign Application Priority Data
May 25, 2011 (AU) 2011902039
Jan. 3, 2012 (AU) 2012200028

(51) Int. Cl. H01B 7/295; H01B 7/29

(52) U.S. Cl. 174/110 SR; 174/110 R

(57) ABSTRACT

A fire resistant cable (1.002) having a polymeric layer (1.004) which forms a cohesive shell on exposure to elevated temperatures, and a conductor (1.006) substantially composed of a metal, alloy or combination of metals and alloys having a melting point suitable for use in a circuit integrity or fire resistant cable application. The cable can include aluminium wires, with or without wires of other material.

### RELATED APPLICATION

This application claims the benefit of priority from Australian Patent Application No. 2011-902039 filed on May 25, 2011, and Australian Patent Application No. 2012-200028 filed on Jan. 3, 2012, the entirety of which are incorporated by reference.

### FIELD OF THE INVENTION

This invention relates to fire resistant cables.

### BACKGROUND OF THE INVENTION

Fire resistant cables are required to maintain the ability to conduct electricity after being subjected to fire. This means that the conductor must retain mechanical continuity and electrical conductivity, and the insulation must retain sufficient insulating characteristics to prevent shorting between the conductors, and must also have sufficient mechanical cohesion to form a continuous layer on the conductors.

The requirement for the conductor to maintain mechanical continuity has discouraged the use of aluminium in fire resistant cables because aluminium has a melting point of about 660° C. Thus copper, with a melting point of 1083° C., is more commonly specified in fire resistant cables. Copper has a melting point of about 1083° C. Aluminium melts at a much lower temperature, of the order of 660° C. Fire resistant cables can be expected to retain circuit integrity to about 1000° C. Ostensibly, aluminium would appear to be unsuitable for use in conductors in such fire resistant cables.

US20080124544 discloses a fire resistant copper cable having a outer layer which forms a ceramic layer on exposure to fire. A low melting point glaze is interposed between the ceramifying sheath and the copper conductor to reduce the cooling thermal stress between the copper conductor and the ceramic after the fire.

JP63192895 discloses a process for forming a ceramic film on a metallic member by first forming an anodic oxide layer on the metal member in a sulphuric acid solution and then applying a ceramic coating by vapour deposition.

### SUMMARY OF THE INVENTION

An “elevated temperature” includes a temperature in the range normally specified for fire resistant cables, typically from about 650° C. to about 1000° C. However, the formation of a cohesive shell as described herein at temperatures outside this range is within the scope of the invention.

According to an embodiment of the invention, there is provided a fire resistant cable (1.002) having afire resistant layer (1.004) which forms a cohesive shell on exposure an elevated temperature, and at least one conductor (1.006) made from a non-copper material.

The conductor can be made from a material having a melting temperature less than the melting temperature of copper.

The conductor can be an aluminium conductor or an aluminium alloy conductor.

In a particular embodiment when the conductor is an aluminium conductor or an aluminium alloy conductor, the conductor is not subjected to any oxidizing step, such as for example an anodizing step, to form a layer of alumina, before being insulated by said fire resistant layer.

The cable can include wires of differing materials.

The wires can include strength wires.

The cable can include at least one steel wire.

The fire resistant layer can be an external fire resistant layer.

The fire resistant layer can be an internal layer.

The cable can be required to maintain circuit integrity at a temperature of above 1000° C., and wherein the conductor can have a melting temperature lower than the required or specified temperature of the cable.

The fire resistant layer can include material which forms a ceramic on exposure to elevated temperature.

The fire resistant layer can at least partially retain electrical insulation after exposure to elevated temperature.

The cable can include an additional layer (2.008) which provides electrical insulation after exposure to fire.

The additional layer can be located between the fire resistant layer and the conductor.

The fire resistant layer which forms a ceramic under fire conditions can made from a composition comprising: at least 10% by weight of mineral silicate; from 8% to 40% by weight of at least one inorganic phosphate that forms a liquid phase at a temperature of no more than 800° C. selected from ammonium phosphate, ammonium polyphosphate and ammonium pyrophosphate; and at least 15% by weight based on the total weight of the composition of a polymer base composition comprising at least 50% by weight of an organic polymer; said composition being essentially free of charring agents which together with said inorganic phosphate provide intumescence; wherein said composition forms a self-supporting ceramic residue on exposure to a temperature of 1000° C. for 30 minutes which reside comprises at least 40% by weight of the composition before pyrolising.

The mineral silicate is present in an amount of at least 15% by weight of the total composition.

The composition can further comprise inorganic filler comprising at least one compound selected from the group consisting of magnesium hydroxide, alumina trihydrate, magnesium carbonate and calcium carbonate and is present in an amount of from 5 to 20% by weight of the total ceramifying composition.

The composition can comprise calcium carbonate in an amount of from 5 to 20% by Weight of the total ceramifying composition.

There can be at least one conductor and at least one insulating layer.

The cable can have a single insulating layer about the conductor.

The ceramifying single insulating layer can have an inner surface abutting the conductor and a free outer surface.

The single insulating layer can have an outer surface free of coatings.

The single insulating layer can form a self-supporting ceramic on exposure to temperature experienced under fire conditions.

Ammonium polyphosphate as inorganic phosphate can be present in an amount in the range of from 8% to 20% by weight of the total ceramifying composition.

The cable can include at least one non-aluminium wire or conductor.

The fire resistant layer can be made from a material including: at least 15% by weight based on the total weight of the composition of a polymer base composition comprising at least 50% by weight of an organic polymer; at least 15% by weight based on the total weight of the composition of a silicate mineral filler; and at least one source of fluxing oxide which is optionally present in said silicate mineral filler, wherein after exposure to an elevated temperature experienced under fire conditions, a fluxing oxide is present in an amount of from 1 to 15% by weight of the residue.

The silicate mineral filler can be present in an amount of at least 25% by weight based on the total weight of the composition.

The fluxing oxide can be present in the residue in an amount of 1-10 wt. % after exposure to said elevated temperatures.

The fluxing oxide can be present in the residue in an amount of 2-8 wt % of the residue after exposure to said elevated temperature.

The weight of the residue after firing can be at least 40% of the fire resistant composition.

The composition can form a self-supporting structure when heated to an elevated temperature experienced under fire conditions.

The fluxing oxide can include at least one fluxing oxide selected from the group consisting of:
fluxing oxide generated by the silicate mineral filler being heated to an elevated temperature,
fluxing oxide as such, and
fluxing oxide precursor forming fluxing oxide by thermal decomposition of said precursor.

The fluxing oxide as such can include one or more of boron oxide or a metal oxide selected from the oxides of lithium, potassium, sodium, phosphorus, and vanadium.

The fluxing oxide may be generated by heating certain silicate mineral fillers (eg mica), it can be separately added or it is also possible to include in compositions of the present invention, a precursor of the fluxing oxide (eg a metal hydroxide or metal carbonate precursors to the metal oxides), that is a compound that yields the fluxing oxide following exposure at the kind of elevated temperatures likely to be encountered in a fire.

The fluxing oxide precursor can include one or more materials selected from the group consisting of borates, metal hydroxides, metal carbonates and glasses.

The fluxing oxide added or derived from precursors can include at least one oxide of an element selected from the group consisting of lead, antimony, boron, lithium, potassium, sodium, phosphorous and vanadium.

The organic polymer can be selected from the group of thermoplastic polymers, thermoset polymers and elastomers.

The organic polymer can include at least one of homopolymer or copolymer or elastomer or resin of polyolefins, ethylene-propylene rubber, ethylene-propylene terpolymer rubber (EPDM), chlorosulfonated polyethylene and chlorinate polyethylene, vinyl polymers, acrylic and methacrylic polymers, polyamides, polyesters, polyimides, polyoxymethylene acetals, polycarbonates, polyurethanes, natural rubber, butyl rubber, nitrile-butadiene rubber, epichlorohydrin rubber, polychloroprene, styrene polymers, styrene-butadiene, styrene-isoprene-styrene, styrene-butadiene-styrene, styrene-ethylene-butadiene-styrene, epoxy resins, polyester resins, vinyl ester resins, phenolic resins, and melamine formaldehyde resins.

The polymer base composition can include from 15 to 75 wt % of the formulated fire resistant composition.

The silicate mineral filler can include at least one selected from the group consisting of alumino-silicates, alkali alumino-silicates, magnesium silicates and calcium silicates.

The fire resistant composition can include an additional inorganic filler selected from the group consisting of silicon dioxide and metal oxides of aluminium, calcium, magnesium, zircon, zinc, iron, tin and barium and inorganic fillers which generate one or more of these oxides when they thermally decompose.

The polymer base composition can include a silicone polymer.

The weight ratio of organic polymer to silicone polymer can be within the range of 5:1 to 2:1.

The fire resistant composition can include a silicone polymer in an amount of from 2 to 15 wt. % based on the total weight of the formulated fire resistant composition.

The elevated temperature experienced under fire conditions can be 1000° C. for 30 minutes.

The composition can include 20 to 75% by weight of said polymer base composition being a silicone polymer; at least 15% by weight of an inorganic filler wherein said inorganic filler comprises mica and a glass additive; and wherein the fluxing oxide in the residue is derived from glass and, mica wherein, the ratio of mica:glass is in the range of from 20:1 to 2:1

The polymer base composition comprises organic polymer and silicone polymer in the weight ratio of from 5:1 to 2:1; said inorganic filler can include 10 to 30% by weight of the total composition of mica and 20 to 40% by weight of the total composition of an additional inorganic filler.

The fluxing oxide can be present in the residue in an amount in excess of 5% by weight of the residue, said fluxing oxide forming a glassy surface layer on the ceramic formed on exposure to fire, said glassy surface layer forming a barrier layer which increases the resistance to passage of water and gases.

The cable can be of any suitable construction.

The cable can be a twisted pair cable (3.010).

The cable can be a parallel wire cable.

The cable can be a multi-conductor cable.

The cable can be a multi-pair construction.

### BRIEF DESCRIPTION OF THE DRAWINGS

An embodiment or embodiments of the present invention will now be described, by way of example only, with reference to the accompanying drawings, in which:

FIG. 1 illustrates a cross-section of a fire resistant cable according to a first embodiment of the invention.

FIG. 2 illustrates a cross-section of a fire resistant cable according to a second embodiment of the invention.

FIG. 3 illustrates a segment of a twisted pair cable according to an embodiment of the invention.

FIG. 4 illustrates a cross-section of a cable according to another embodiment of the invention.

The numbering convention used in the drawings is that the digits in front of the full stop indicate the drawing number, and the digits after the full stop are the element reference numbers. Where possible, the same element reference number is used in different drawings to indicate corresponding elements.

The orientation of the drawings may be chosen to illustrate features of the embodiment of the invention, and should not be considered as a limitation on the orientation of the invention in use.

The drawings are intended to illustrate the inventive features of the embodiments illustrated and are not necessarily to scale.

### DETAILED DESCRIPTION OF THE EMBODIMENT

The invention will be described with reference to the embodiments illustrated in the accompanying drawings.

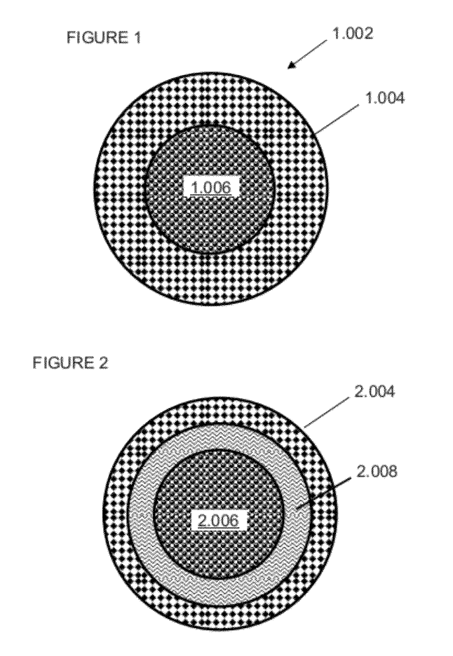

FIG. 1 shows a cross-section of a cable 1.002 having an insulating fire resistant layer or jacket 1.004 encompassing a conductor 1.006. The fire resistant layer can be made of a material which forms a cohesive residue on exposure to elevated temperature such as may be experienced during fire.

The fire resistant layer can be made of a ceramifying material which forms a ceramic on exposure to elevated temperature.

WO2005/095545, the specification of which is incorporated herein by reference, describes compositions suitable for use as the fire resistant layer.

### Example 1

A two-roll mill was used to prepare the compositions denoted A, B, C and D in Table 1. In each case, the ethylene-propylene (EP) polymer was banded on the mill (10-20° C.) and other components were added and allowed to disperse by separating and recombining the band of material just before it passed through 10 the nip of the two rolls. When these were uniformly dispersed, the peroxide was added and dispersed in a similar manner.

Flat rectangular sheets of about 1.7 mm thickness were fabricated from the milled compositions by curing and moulding at 170° C. for 30 minutes under a pressure of approximately 7 MPa.

Rectangular sheet specimens with dimensions 30 mm×13 mm×1.7 mm (approx) were cut from the moulded sheets and fired under slow firing conditions (heating from room temperature to 1000° C. at a temperature increase 20 rate of 12° C./min followed by holding at 1000° C. for 30 minutes) or fast firing conditions (putting sheets into a pre-heated furnace at 1000° C. and maintaining at that temperature for 30 minutes). After firing, each sample took the form of a ceramic. The change in linear dimensions caused by firing was determined by measuring the length of the specimen before and after firing. An expansion of the specimen caused by firing is reported as a positive change in linear dimensions and a contraction (shrinkage) as a negative change in linear dimensions.

TABLE 1
Compositions A, B, C and D

| | Composition (weight %) | | | | |
|---|---|---|---|---|---|
| | A | | B | C | D |
| EP Polymer | 18 | | 18 | 18 | 18 |
| EVA Polymer | 4.5 | | 4.5 | 4.5 | 4.5 |
| Ammonium Polyphosphate | 27 | | 27 | 27 | 27 |
| Talc | 25 | | 40 | 25 | |
| Mica | | | | | 25 |
| Alumina Trihydrate | 15 | | | | 15 |
| Magnesium Hydroxide | | | | 15 | |
| Other Additives (Stabilisers, Coagent, | 8 | | 8 | 8 | 8 |
| Paraffinic Oil) | | | | | |
| Peroxide | 2.5 | | 2.5 | 2.5 | 2.5 |
| TOTAL: | 100 | | 100 | 100 | 100 |
| Firing Condition | Slow | Fast | Slow | Slow | Slow |
| Change in linear dimesnions when | −2.9 | 2.0 | 0.2 | 6.7 | −2.1 |
| ceramified as % | | | | | |

On firing at 1000° C., the compositions A, B, C and D transform into hard and strong ceramics that retain the initial shape with minimum dimensional changes.

### Example 2

This example tests the performance of the composition denoted “E” in Table 2. In this example the EP polymer was banded on the mill (40-50° C.) and other components were added and allowed to disperse by separating and recombining the band of material just before it passed through the nip of the two rolls. When these were uniformly dispersed, the peroxide was added and dispersed in a similar manner.

Flat rectangular sheets of about 1.7 mm thickness were fabricated from the milled compositions by curing and moulding at 170° C. for 30 minutes under a pressure of approximately 7 MPa.

Rectangular sheet specimens with dimensions 30 mm×13 mm×1.7 mm (approx) were cut from the moulded sheets and fired under fast firing conditions (insertion into a furnace maintained at 1000° C. followed by holding at 1000° C. for 30 minutes). After firing, the sample took the form of a ceramic. Visual examination confirmed that composition “E” had formed a ceramic residue that had maintained its original dimensions. A test formed under slow firing conditions showed that composition “E” was self supporting. Composition “E” showed net shape retention (excellent dimensional stability).

TABLE 2

| | COMPOSITION E |
|---|---|
| | % weight |
| EP Polymer | 18.50 |
| EVA Polymer | 4.70 |
| Ammonium Polyphosphate | 13.50 |
| Talc | 20.00 |
| Clay | 7.50 |
| Alumina Trihydrate | 15.00 |
| Calcium Carbonate | 7.50 |
| Process oil | 5.80 |
| Coupling agent | 1.00 |
| Process aid | 2.50 |
| Stabiliser) | 1.40 |
| Peroxide | 2.60 |
| TOTAL: | 100.00 |

### Example 3

This example relates to preparation of thermoplastic compositions in accordance with the invention. Compositions shown in Table 3 were prepared.

TABLE 3

| | COMPOSITION G | COMPOSITION H |
|---|---|---|
| | TPV | EPDM |
| THERMOPLASTICS | % weight | % weight |
| TPV | 29.8 | |
| EPDM | | 30 |
| Ammonium Polyphosphate | 28.0 | 28.2 |
| Alumina Trihydrate | 15.60 | 15.70 |
| Talc | 25.9 | 26.1 |
| Process aids | 0.7 | 0 |
| TOTAL: | 100.00 | 100.00 |

Compositions G and H in Table 3 were prepared by mixing the polymers with the respective filler and additive combination using a Haake Record Batch Mixer.

Composition G was based on a thermoplastic vulcanizate (TPV, Santoprene 591-73), with calcium stearate and paraffin used as processing aids premixed with the TPV pellets and fillers respectively, and then 10 mixed in the same way as for the polystyrene composition.

Composition H was based on an ethylene propylene diene polymer (Nordel 3745). This composition was not crosslinked. It was mixed at a 15 temperature of 1700 C but otherwise per Composition G.

3 mm thick plaques were compression moulded from these compositions at 155 to 180° C. for approximately 10 minutes under a pressure of approximately 10 MPa. Specimens were then cut from the plaques. One set of specimens was fired under the slow firing conditions and tested as described above. These two compositions based on thermoplastics produced self-supporting ceramics after slow firing with less than 10% change in linear dimensions and flexural strength greater than 0.3 MPa.

A suitable composition for the cohesive layer can include at least 15% by weight based on the total weight of the composition of a polymer base composition comprising at least 50% by weight of an organic polymer; at least 15% by weight based on the total weight of the composition of a silicate mineral filler; and at least one source of fluxing oxide which is optionally present in said silicate mineral filler, wherein after exposure to an elevated temperature experienced under fire conditions, a fluxing oxide is present in an amount of from 1 to 15% by weight of the residue.

The silicate mineral filler can be present in an amount of at least 25% by weight based on the total weight of the composition.

The fluxing oxide can be present in the residue in an amount of 1-10 wt. % after exposure to said elevated temperatures.

The fluxing oxide can be present in the residue in an amount of 2-8 wt % of the residue after exposure to said elevated temperature.

The weight of the residue after firing can be at least 40% of the fire resistant composition.

### Further Examples

WO2004/035711, the specification of which is incorporated herein by reference, describes compositions which may suitable for use as the fire resistant layer. In respect of these examples the composition can form a self-supporting structure when heated to an elevated temperature experienced under fire conditions.

The fluxing oxide can be generated by the silicate mineral filler being heated to an elevated temperature.

The fluxing oxide precursor can include one or more materials selected from the group consisting of borates, metal hydroxides, metal carbonates and glasses.

The fluxing oxide added or derived from precursors can include at least one oxide of an element selected from the group consisting of lead, antimony, boron, lithium, potassium, sodium, phosphorous and vanadium.

The organic polymer can be selected from the group of thermoplastic polymers, thermoset polymers and elastomers.

The organic polymer can include at least one of homopolymer or copolymer or elastomer or resin of polyolefins, ethylene-propylene rubber, ethylene-propylene terpolymer rubber (EPDM), chlorosulfonated polyethylene and chlorinate polyethylene, vinyl polymers, acrylic and methacrylic polymers, polyamides, polyesters, polyimides, polyoxymethylene acetals, polycarbonates, polyurethanes, natural rubber, butyl rubber, nitrile-butadiene rubber, epichlorohydrin rubber, polychloroprene, styrene polymers, styrene-butadiene, styrene-isoprene-styrene, styrene-butadiene-styrene, styrene-ethylene-butadene-styrene, epoxy resins, polyester resins, vinyl ester resins, phenolic resins, and melamine formaldehyde resins.

The polymer base composition can include from 15 to 75 wt % of the formulated fire resistant composition.

The silicate mineral filler can include at least one selected from the group consisting of alumino-silicates, alkali alumino-silicates, magnesium silicates and calcium silicates.

The fire resistant composition can include an additional inorganic filler selected from the group consisting of silicon dioxide and metal oxides of aluminium, calcium, magnesium, zircon, zinc, iron, tin and barium and inorganic fillers which generate one or more of these oxides when they thermally decompose.

The polymer base composition can include a silicone polymer.

The weight ratio of organic polymer to silicone polymer can be within the range of 5:1 to 2:1.

The fire resistant composition can include a silicone polymer in an amount of from 2 to 15 wt. % based on the total weight of the formulated fire resistant composition.

The elevated temperature experienced under fire conditions can be 1000° C. for 30 minutes.

The composition can include 20 to 75% by weight of said polymer base composition being a silicone polymer; at least 15% by weight of an inorganic filler wherein said inorganic filler comprises mica and a glass additive; and wherein the fluxing oxide in the residue is derived from glass and, mica wherein, the ratio of mica:glass is in the range of from 20:1 to 2:1

The polymer base composition comprises organic polymer and silicone polymer in the weight ratio of from 5:1 to 2:1; said inorganic filler can include 10 to 30% by weight of the total composition of mica and 20 to 40% by weight of the total composition of an additional inorganic filler.

The fluxing oxide can be present in the residue in an amount in excess of 5% by weight of the residue, said fluxing oxide forming a glassy surface layer on the ceramic formed on exposure to fire, said glassy surface layer forming a barrier layer which increases the resistance to passage of water and gases.

The maximum amount of this component tends to be dictated by the processability of the composition. Very high levels of filler can make formation of a blended composition difficult. Usually, the maximum amount of silicate mineral filler would be about 80% by weight. The amount and type of silicate mineral filler used will also be dictated by the requirement to have a certain range of fluxing oxide in the residue formed by heating the composition at elevated temperatures experienced under fire conditions.

The fluxing oxide can be generated in situ at elevated temperature by heating certain types of silicate mineral fillers (eg mica), to make the fluxing oxide become available at the surfaces of the filler particles. Additionally, or alternatively the fluxing oxide may come from a source other than the silicate mineral filler. As is explained later, the fluxing oxide is believed to act as an “adhesive” assisting in formation of a coherent product at high temperature. The fluxing oxide is believed to contribute a binding flux at the edges of the filler particles. The presence of a high proportion of silicate mineral filler results in a composition which is likely to exhibit low shrinkage and cracking when a ceramic is formed at elevated temperature, and on cooling of the ceramic.

The fluxing oxide can be boron oxide or a metal oxide selected from the oxides of lithium, potassium, sodium, phosphorus, and vanadium.

The fluxing oxide may be generated by heating certain silicate mineral fillers (eg mica), it can be separately added or it is also possible to include in compositions of the present invention, a precursor of the fluxing oxide (eg a metal hydroxide or metal carbonate precursors to the metal oxides), that is a compound that yields the fluxing oxide following exposure at the kind of elevated temperatures likely to be encountered in a fire.

The core can be a conductor which has a melting point lower than copper.

The core can be a conductor which has a melting point below the temperature required or specified for circuit integrity of the cable.

The core conductor can be aluminium or an aluminium alloy.

In a further embodiment of the invention as shown in FIG. 2, an intermediate 2.008 layer is applied between the conductor 2.006 and the jacket 2.004. The jacket 2.004 forms a cohesive layer on exposure to elevated temperatures.

The intermediate layer 2.008 can be a buffer layer to reduce the interaction between the conductor and the fire resistant layer.

The intermediate layer can be an insulating layer which retains insulative properties after exposure to elevated temperature.

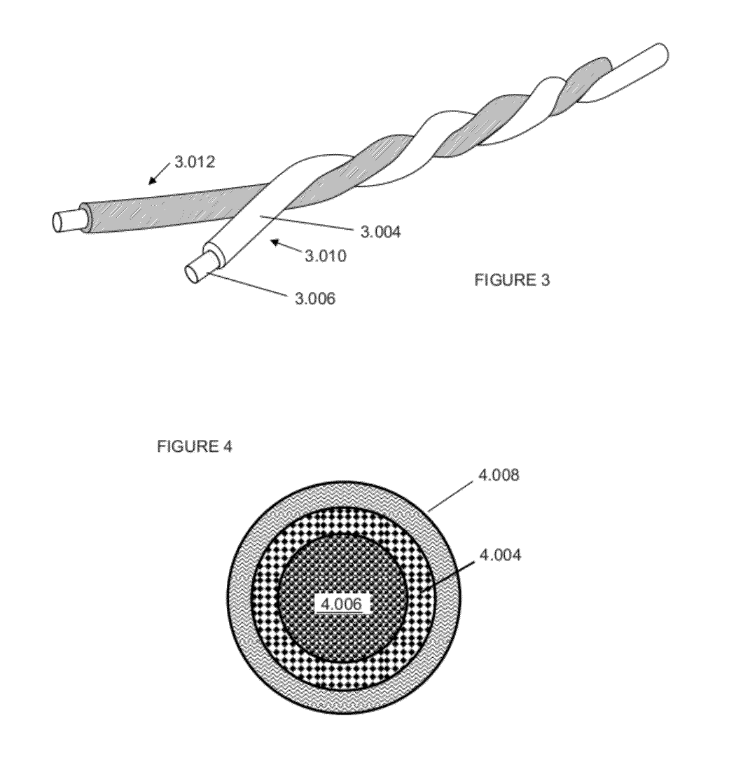

FIG. 3 illustrates a twisted pair cable having a first insulated cable 3.010 intertwined with a second insulated cable 3.012. The cable 3.010 has an aluminium or aluminium alloy conductor 3.003 and an insulating fire resistant layer 3.004. The fire resistant layer 3.004 can be made from a ceramifying material. The conductor 3.012 can be of the same construction as cable 3.010.

FIG. 4 shows a cross-section of a cable according to a further embodiment of the invention, in which a first ceramifying fire resistant layer 4.004 is applied over the conductor 4.006, and a second ceramifying layer is applied over the first ceramifying fire resistant layer. The second layer can be provided to improve high temperature insulation characteristics of the cable.

We have tested aluminium conductors in a twisted pair cable by exposing them to temperatures above 1000° C., and have found that such cables continue to retain effective insulation at these elevated temperatures. The insulating fire resistant layer was made from a material which forms a cohesive jacket after exposure to high temperatures. The cohesive jacket retained sufficient insulative characteristics to provide effective insulation after exposure to the elevated temperature.

Samples of the cables were tested for 30 minutes at 800° C. and 1000° C. For the aluminium cable when tested for 45 minutes at 1000° C., melted conductor flowed from the end of the cable when removed from the furnace, but the integrity of the conductor was maintained within the ceramic fire resistant layer.

The surprising result of these experiments was that conductors with melting points below the elevated temperatures can be used in fire resistant cables with an insulating fire resistant layer which forms a cohesive insulation jacket on exposure to fire.

In particular, aluminium and its alloys are suitable for use in such fire resistant cables. Aluminium forms a surface layer of Al₂O₃ on exposure to air. Al₂O₃ has a very high melting point of the order of 2072° C., so the Al₂O₃ skin does not melt at the specified or required circuit integrity temperature of the cable. Thus, above the melting point of the aluminium or aluminium alloy, the interior of the conductor will be molten metal, which will be contained in a solid skin of Al₂O₃. In addition, Al₂O₃ has low thermal conductivity and slows the rate of heat transfer to the interior of the interior of the aluminium or aluminium alloy wire. Thus, the conductor is exposed to a lower rate of heating than would be the case without the Al₂O₃ layer.

Aluminium alloys can also be used for this purpose. A readily available aluminium alloy is the 1120 alloy which has greater strength and creep resistance than plain aluminium.

Aluminium forms a layer or skin of Al₂O₃ in air. The ceramifying composition can be extruded over an untreated aluminium or aluminium alloy conductor. The present invention does not require an anodizing process or a vapour deposition process as described in JP63192895.

In this specification, reference to a document, disclosure, or other publication or use is not an admission that the document, disclosure, publication or use forms part of the common general knowledge of the skilled worker in the field of this invention at the priority date of this specification, unless otherwise stated.

In this specification, terms indicating orientation or direction, such as “up”, “down”, “vertical”, “horizontal”, “left”, “right” “upright”, “transverse” etc. are not intended to be absolute terms unless the context requires or indicates otherwise.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A fire resistant cable comprising:
a fire resistant layer which forms a cohesive shell on exposure to an elevated temperature, wherein the cable includes at least one conductor made from a material having a melting temperature less than the melting temperature of copper.

2. A cable as claimed in claim 1, wherein the conductor is an aluminium conductor or an aluminium alloy conductor.

3. A cable as claimed in claim 1, wherein the fire resistant layer includes material which forms a ceramic on exposure to elevated temperature.

4. A cable as claimed in claim 1, wherein the fire resistant layer at least partially retains electrical insulation after exposure to elevated temperature.

5. A cable as claimed in claim 1, wherein the cable includes an additional layer which provides electrical insulation after exposure to fire.

6. A cable as claimed in claim 5, wherein the additional layer is located between the fire resistant layer and the conductor.

7. A cable as claimed in claim 6, wherein the fire resistant layer which forms a ceramic under fire conditions is made from a composition comprising:
at least 10% by weight of mineral silicate; from 8% to 40% by weight of at least one inorganic phosphate that forms a liquid phase at a temperature of no more than 800° C. selected from the group consisting of ammonium phosphate, ammonium polyphosphate and ammonium pyrophosphate; and
at least 15% by weight based on the total weight of the composition of a polymer base composition comprising at least 50% by weight of an organic polymer; said composition being essentially free of charring agents which together with said inorganic phosphate provide intumescence;
wherein said composition forms a self-supporting ceramic residue on exposure to a temperature of 1000° C. for 30 minutes which reside comprises at least 40% by weight of the composition before pyrolising.

8. A cable as claimed in claim 7 wherein said mineral silicate is present in an amount of at least 15% by weight of the total composition.

9. A cable as claimed in claim 8, wherein the composition further comprises inorganic filler comprising at least one compound selected from the group consisting of magnesium hydroxide, alumina trihydrate, magnesium carbonate and calcium carbonate and is present in an amount of from 5 to 20% by weight of the total ceramifying composition.

10. A cable as claimed in claim 7, wherein the composition comprises calcium carbonate in an amount of from 5 to 20% by weight of the total ceramifying composition.

11. A cable as claimed in claim 1, wherein there is at least one conductor and at least one insulating layer.

12. A cable as claimed in claim 1, wherein said cable has a single insulating layer about the conductor.

13. A cable as claimed in claim 11, wherein said ceramifying single insulating layer has an inner surface abutting the conductor and a free outer surface.

14. A cable as claimed in claim 13, wherein said single insulating layer has an outer surface free of coatings.

15. A cable as claimed in claim 11, wherein the single insulating layer forms a self-supporting ceramic on exposure to temperature experienced under fire conditions.

16. A cable as claimed in claim 7, wherein ammonium polyphosphate as inorganic phosphate is present in an amount in the range of from 8% to 20% by weight of the total ceramifying composition.

17. A cable as claimed in claim 1, including at least one non-aluminium wire or conductor.
